(19) United States
(12) Patent Application Publication
(10) Pub. No.: US 2012/0165998 A1
(43) Pub. Date: Jun. 28, 2012

(54) APPARATUS FOR VERIFYING AND MANAGING CONSUMPTION ELECTRIC POWER DATA IN A GREEN HOME ELECTRIC POWER MANAGEMENT SYSTEM AND METHOD THEREOF

(75) Inventors: Chang-Sic CHOI, Daejeon (KR); Jinsoo HAN, Daejeon (KR); Wan Ki PARK, Daejeon (KR); Jeong In LEE, Daejeon (KR); Il Woo LEE, Daejeon (KR)

(73) Assignee: Electronics and Telecommunications Research Institute, Daejeon (KR)

(21) Appl. No.: 13/334,641

(22) Filed: Dec. 22, 2011

(30) Foreign Application Priority Data
Dec. 22, 2010 (KR) 10-2010-0132070

(51) Int. Cl. G06F 1/28

(52) U.S. Cl. 700/286

(57) ABSTRACT

An apparatus for verifying and managing consumption electric power data in a green home electric power management system includes: an electric management object structure configured according to an outlet of home, an electric power sensor node of a hole of the outlet, a device and a device; and a consumption electric power data management apparatus for storing a consumption electric power data transmitted from an electric power measuring module embedded outlet and a time information table in the electric management object structure and managing consumption electric power information. The apparatus further includes a verifying apparatus for generating a simulation consumption electric power data.

### CROSS-REFERENCE(S) TO RELATED APPLICATION(S)

The present invention claims priority of Korean Patent Application No. 10-2010-0132070, filed on Dec. 22, 2010, which is incorporated herein by reference.

### FIELD OF THE INVENTION

The present invention relates to a green home electric power management system for the integrated management of home electric power energy; and, more particularly, to an apparatus for verifying and managing consumption electric power data in a green home electric power management system and method thereof which are suitable for managing effectively electric power consumption data of each device collected from an electric power measuring module and implementing a simulator for verifying the function thereof.

### BACKGROUND OF THE INVENTION

Recently, climate convention based on carbon emission reduction is being made and demand for green technology for green growth is being increased. In addition, effort for reducing energy consumption is being made in home.

Electric power provider collects electric power consumption information of each home using on a smart meter based on remote reading base and uses the information for establishing energy supply and demand policy. In addition, the electric power provider is performing a research for preparing for later smart grid or demand responsive real time charge. It is studied a technology for monitoring consumption electric power of target device by installing an electric power measuring module in the outlet and transmitting the consumption electric power information to the server via wired/wireless network.

However, the technology is being studied to the extent that total consumption electric power quantity and individual consumption electric power is collected and monitored periodically at home. Thus, the total flow of the consumption electric power quantity can be merely analyzed by the technology.

As described above, in conventional green home electric power management system, consumption electric power of each device is received from the electric power measuring module installed in the outlet and the periodic information for an electric power consumption pattern is provided via a GUI. However, it is difficult for the conventional green home electric power management system to analyze various electric power consumption patterns according to a device, a device and a time. Furthermore, when the collected data is large, the realization of efficient search function at high speed can be difficult.

In addition, there exists problem since the conventional green home electric power management system is operated in an environment where data for many years is accumulated.

### SUMMARY OF THE INVENTION

In view of the above, the present invention provides a green home electric power management system for the integrated management of home electric power energy; and, more particularly, to an apparatus for verifying and managing consumption electric power data in a green home electric power management system and method thereof which are suitable for managing effectively electric power consumption data of each device collected from an electric power measuring module and implementing a simulator for verifying the function thereof.

Further, the present invention provides an apparatus for verifying and managing consumption electric power data in a green home electric power management system and a method thereof which store and manage consumption electric power information collected from each home device through various data structures in order to analyze energy consumption data in various perspectives and can perform verification based on simulator supporting easy electric power functional verification in environment where long-term data storing is difficult.

In accordance with an aspect of the present invention, there is provided an apparatus for verifying and managing consumption electric power data in a green home electric power management system. The apparatus includes: an electric management object structure configured according to an outlet at home, an electric power sensor node of a hole of the outlet, a device and an equipment; a consumption electric power data management apparatus for storing a consumption electric power data transmitted from an electric power measuring module embedded outlet in forms of an object management table and a time information table in the electric management object structure to manage consumption electric power information; and a verifying apparatus for generating simulation consumption electric power data for verifying the consumption electric power data management apparatus.

In accordance with another aspect of the present invention, there is provided a method for verifying and managing consumption electric power data in a green home electric power management system.

The method includes: receiving a consumption electric power data transmitted from a consumption electric power measuring module embedded outlet of a consumption electric power quantity data management apparatus; and storing and managing the received consumption electric power data in forms of an object management table and a time information table in an electric power management object structure.

### BRIEF DESCRIPTION OF THE DRAWINGS

The objects and features of the present invention will become apparent from the following description of embodiments, given in conjunction with the accompanying drawings, in which:

FIG. 1 is a schematic diagram of a green home electric management system based on an outlet into which an electric power measuring module is installed in accordance with an embodiment of the present invention;

FIGS. 2A and 2B show a data structure of objects and mutual relations thereof when each object is defined as the electric power consumption data of each of home devices which are managed in the green home electric power management system in accordance with the embodiment of the present invention.

FIG. 3 depicts a block diagram of a consumption electric power data management apparatus which receives and processes electric power consumption data transmitted from each electric power measuring module in accordance with the embodiment of the present invention;

FIGS. 4A and 4B show a structure of specific data tables in a time information table updated in the electric power quantity statistic information control unit in accordance with the embodiment of the present invention; and

FIG. 5 illustrates a block diagram of an apparatus for verifying a consumption electric power quantity data management apparatus in accordance with the embodiment of the present invention.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, embodiments of the present invention will be described with reference to the accompanying drawings which form a part hereof.

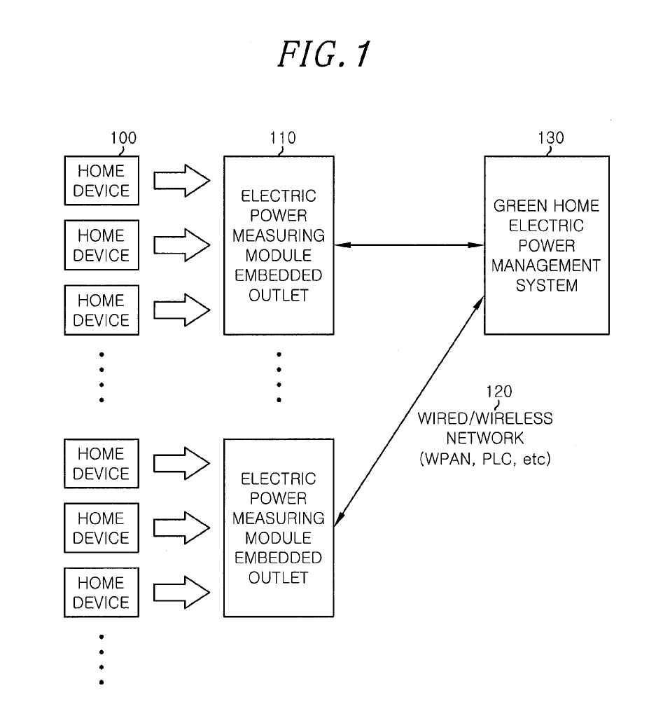

FIG. 1 is a schematic diagram of a green home electric management system based on an outlet into which an electric power measuring module is installed in accordance with an embodiment of the present invention.

Referring to FIG. 1, home devices 100 are target devices of measuring electrical power consumption. The home devices 100 may include all electronic equipments which can be used at home such as a heating and cooling device, an audio video (AV) device, a lighting device, information home devices and the like.

An electric power measuring module embedded electric outlet 110 measures an instantaneous electric power (Watt) and an accumulated electric power quantity (Watt-Hour) of home devices which are installed into each hole of the outlet 110 and transmit electric power measurement information to the green home electric management system 130 via a wired/wireless network 120.

The wired/wireless network 120 may include at least one of wireless network such as Zigbee based on 802.15.4 LR_WPAN, wireless LAN, Bluetooth and ultra wideband (UWB) or the like and wired network such as Ethernet, PLC modem, RS-485 serial communication and the like.

The green home electric power management system 130 can manage the electric power measurement information collected from each of home devices 100 and provide a user with electric power consumption information through a graphic user interface (GUI) in various perspectives. In addition, the green home electric power management system 130 may verify validity and performance for electric power consumption data management.

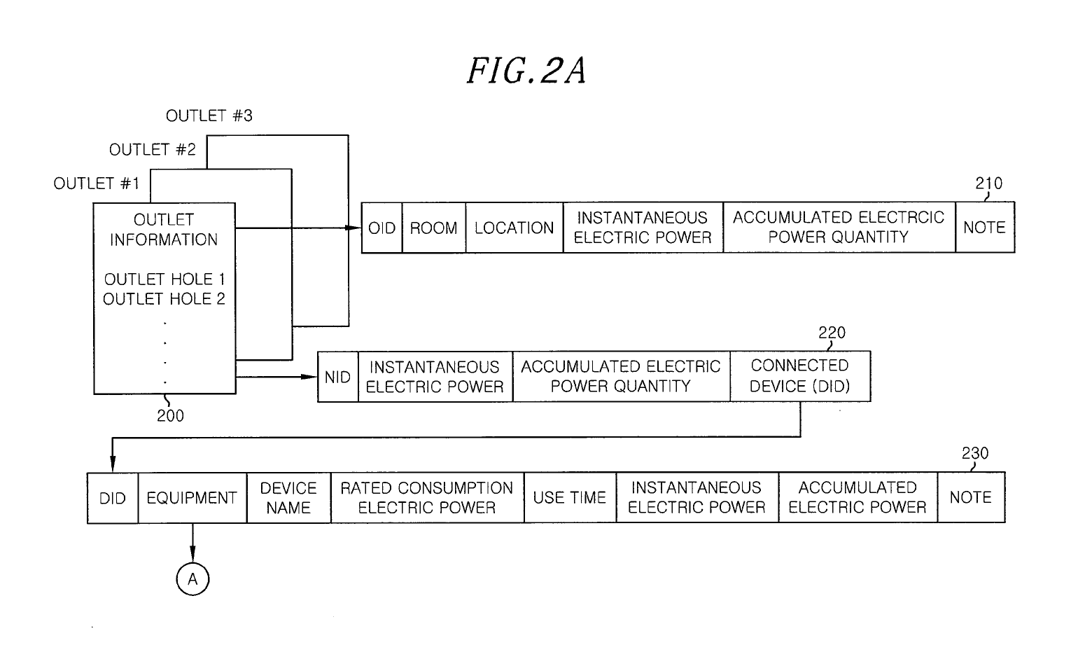

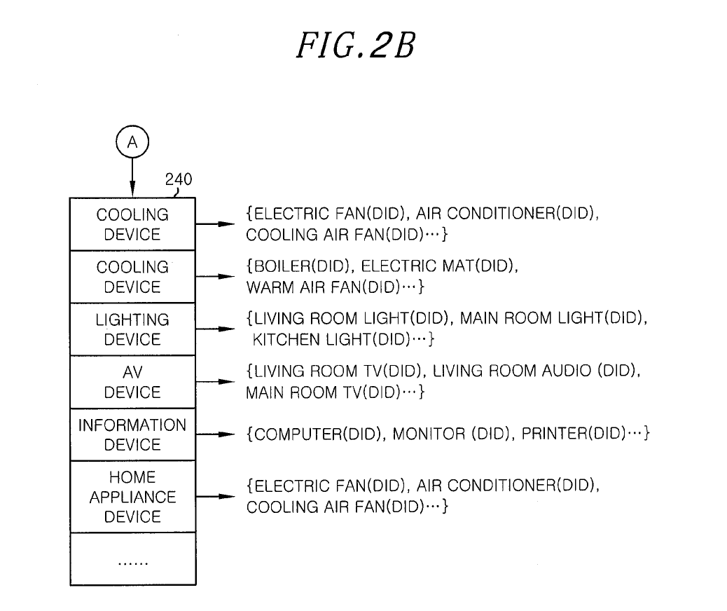

FIGS. 2A and 2B show a data structure of objects and mutual relations thereof when each object is defined as the electric power consumption data of each of home devices which are managed in the green home electric power management system in accordance with the embodiment of the present invention.

Referring to FIGS. 2A and 2B, the electric power management object structure which is stored and managed in the database of the green home electric power management system 130 includes a home outlet table 200, an outlet information table 210, an outlet hole information table 220, a device information table 230 and an equipment information table 240.

The home outlet table 200 is a data structure storing structure information for the outlets installed at home. The home outlet table 200 is provided for each of the outlets. The home outlet table 200 may include the outlet information table 210 representing the information of the outlet itself and the outlet hole information table 220 representing the information for each hole of the respective outlets.

The outlet information table 210 includes data for an outlet ID (OID) of each of the outlets, room information of a room where the outlet is installed (main room, living room or the like), location information in the corresponding room (XYZ coordinates or light upper side, right upper side or the like), and the total instantaneous electric power value and accumulated electric power quantity value of equipments connected to the outlets. The outlet hole information table 220 may include a Node ID (NID) of an electric power sensor connected to the each hole of the respective outlets, the instantaneous electric power and accumulated electric power information measured at the electric power sensor. In addition, the outlet hole information table 220 may further include connection information with the device information table 230 having information for a device actually connected to the each hole.

The device information table 230 may include specific information for a device actually connected to the each hole, a device ID (DID), the kind of a device (heating, cooling, lighting and AV device and the like), a device name, use time, an instantaneous electric power and an accumulated electric power quantity or the like. The equipment information table 240 includes information for classification of the device and device ID information of devices included in each classification.

An analysis in various perspectives can be provided based on electric power consumption information of each device and each location according to the outlet connection through the object of the outlet information, the outlet hole information, the device information and the equipment information and the member data of the object.

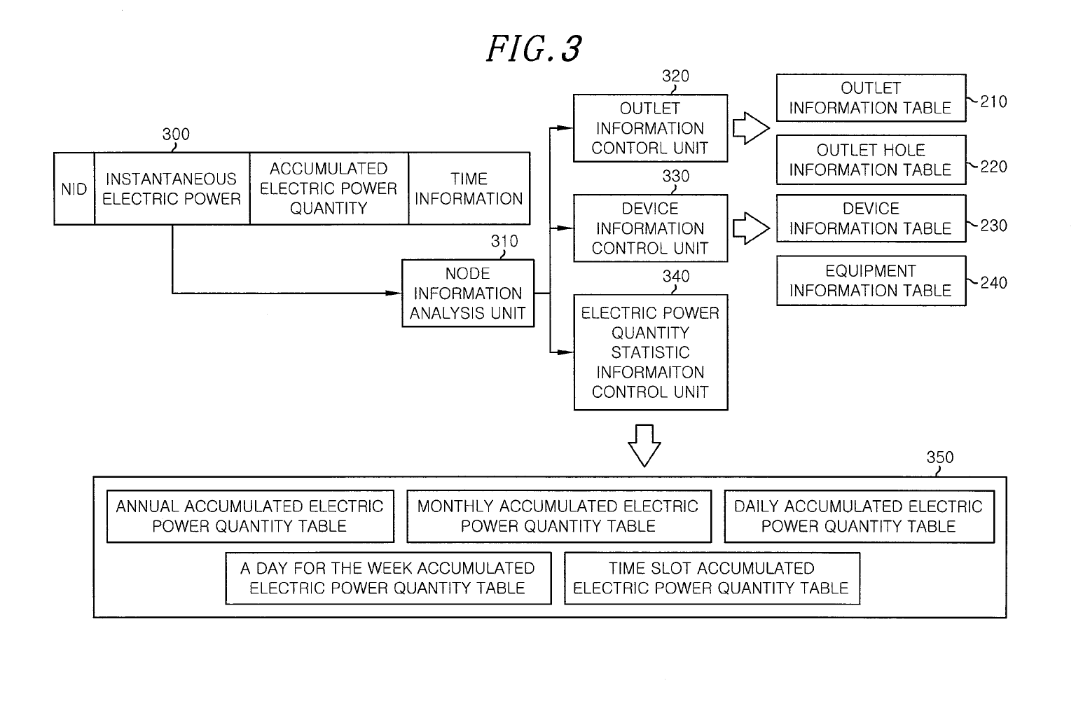

FIG. 3 depicts a block diagram of a consumption electric power data management apparatus which receives and processes electric power consumption data transmitted from each electric power measuring module in accordance with the embodiment of the present invention.

Referring to FIG. 3, the consumption electric power management apparatus may include a node information analysis unit 310, an outlet information control unit 320, a device information control unit 330 and an electric power quantity statistic information control unit 340 and the like.

Device electric power consumption information 300 is transmitted from the electric power measuring module embedded electric outlet 110. The device electric power consumption information 300 may include the NID of the electric power sensor, the instantaneous electric power, the accumulated electric power quantity information and time information for the time when the sensing is performed.

The node information analysis unit 310 may analyze data in a received packet; classify the analyzed electric power consumption information of each device based on an outlet, a device, an equipment, and a time; and transmit the classified information to the outlet information control unit 320 relating to the electric power sensor, the device information control unit 330 and the electric power quantity statistic information control unit 340.

The outlet information control unit 320 updates data corresponding to the NID in the outlet hole information table 220 and updates the sum data value of the instantaneous electric power and the accumulated electric power quantity of the outlet including each hole. The device information control unit 330 updates the instantaneous electric power and accumulated electric power quantity of a corresponding device and equipment of the device information table 230 and the equipment information table 240 based on the DID value extracted from the node information analysis unit 310.

In addition, the electric power quantity statistic information control unit 340 may process various statistic information at high speed by updating simultaneously the values in the respective time tables in a time information table 350 based on the DID value.

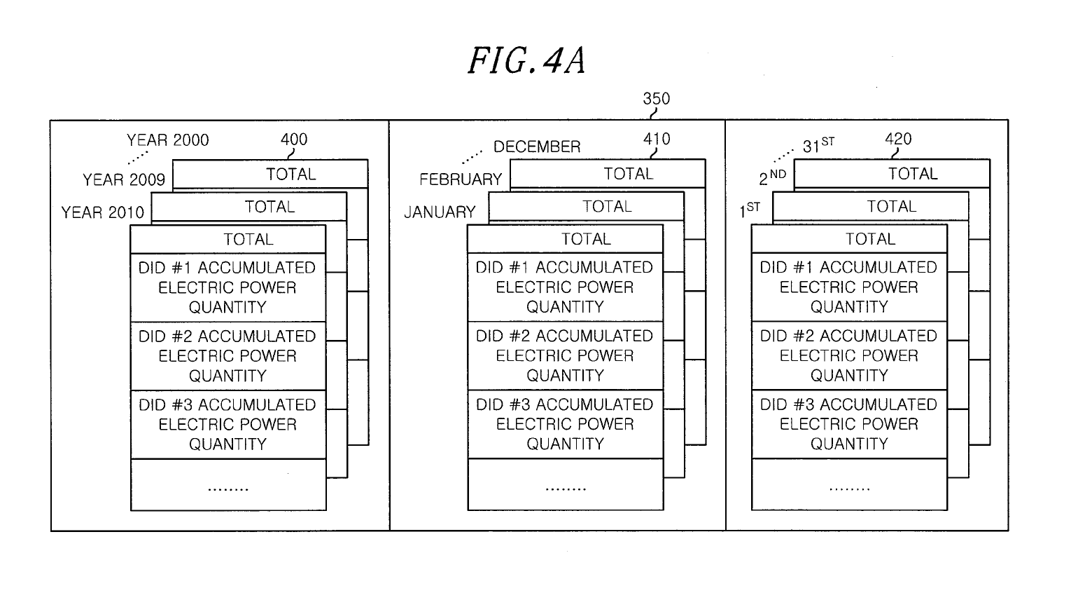

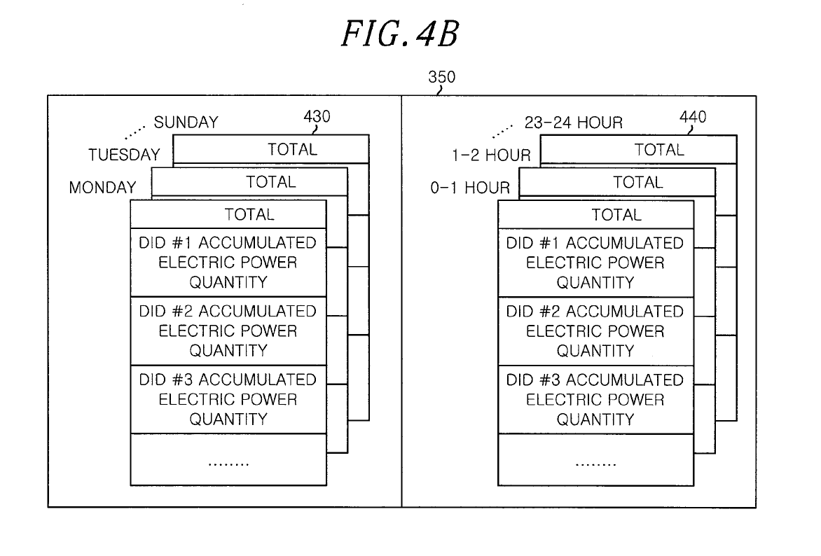

FIGS. 4A and 4B show a specific data structure of the time information table 350 which is updated by the electric power quantity statistic information control unit 340 in accordance with the embodiment of the present invention.

Referring to FIGS. 4A and 4B, the time information table 350 may include an annual accumulated electric power quantity table 400, a monthly accumulated electric power quantity table 410, a daily accumulated electric power quantity table 420, a day of the week accumulated electric power quantity table 430 and a time slot accumulated electric power quantity table 440.

Specifically, the annual accumulated electric power quantity (e.g., total consumption electric power quantity) table 400 may update the value of the accumulated electric power quantity of DID in the corresponding year table according to the time information of the device electric power consumption information 300 shown in FIG. 3 for the each device in the green home. By this, annual total consumption information and consumed electric power quantity information of each device for a specific year can be provided instantaneously.

The monthly accumulated electric power quantity table 410 includes monthly total consumption quantity from January to December and the consumption electric power quantity information of each month for the each device. Thus, total electric power quantity consumed for each month and the monthly consumed electric power quantity of each device may be compared and analyzed.

In addition, the daily accumulated electric power quantity table 420 may record daily electric power quantity consumed from 1^{st} to 31^{st} for a month and thus, analyze pattern for the information of the electric power quantity consumed daily. The day of the week accumulated electric power quantity table 430 and the time slot accumulated electric power quantity table 440 may manage the consumption electric power quantity as total value and value for each device based on from Monday to Sunday and each hour of 24 hours, thus, can have data structure with which instantaneous analysis in various perspective is possible.

In order to construct various tables including annual, monthly, daily, a day of the week and a time slot table and extract statistic and analysis information in various perspectives based on the various tables, data for many years should be accumulated. However, in case that the data accumulation for long time is difficult, simulation data generation function based on a simulator is required for functional validity and supplementation. This can be used for function module which is useful for continuous upgrade process.

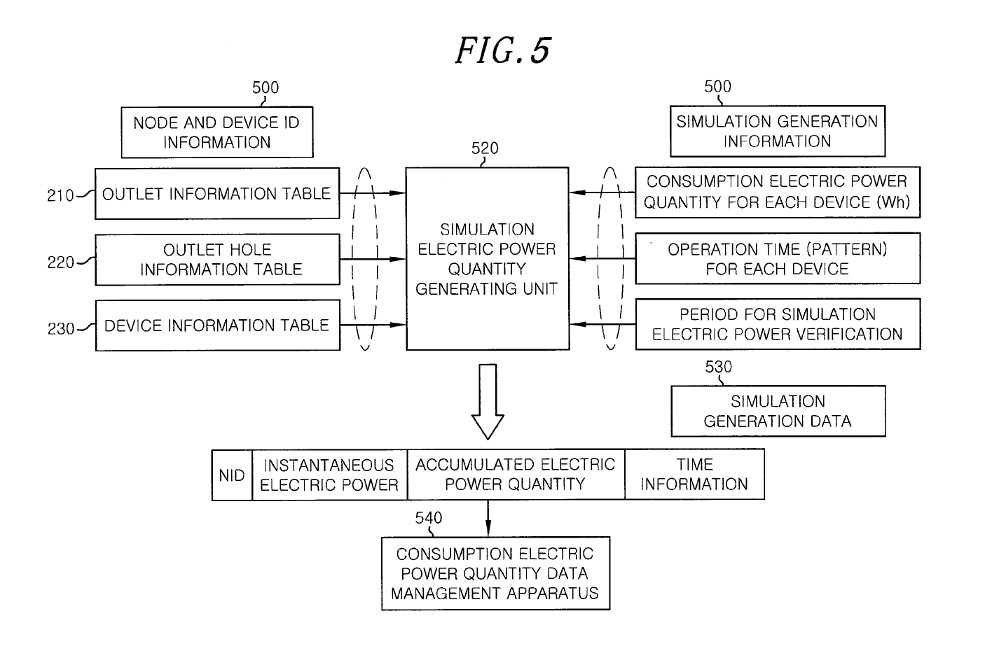

FIG. 5 illustrates a block diagram of an apparatus for verifying a consumption electric power quantity data management apparatus in accordance with the embodiment of the present invention.

Referring to FIG. 5, the apparatus for verifying a consumption electric power quantity data management apparatus may include a simulation electric power quantity generating unit 520 and a consumption electric power quantity data management apparatus 540.

Node and device ID information 500 is an input variable for extracting NID value and DID value from the outlet information table 210, the outlet hole information table 220 and the device information table 230. A simulation generation information 510 may include a rated consumption electric power quantity for each device for which simulation consumption electric power quantity is generated, an operation time, starting time information for generating a simulation data and ending time information for stopping generating the simulation data.

The simulation electric power quantity generating unit 520 may generate a simulation generation data 530 of virtual instantaneous electric power and accumulated electric power considering information for electric power sensor node and outlet to which each device is connected based on such input information. Then, the simulation electric power quantity generating unit 520 transmits the simulation generation data 530 to the consumption electric power quantity data management apparatus 540 as an input data. Here, the simulation generation data 530 is configured to have a same format as a data transmitted from a actual electric power sensor node and the time information can be generated according to variables inputted from the simulation generation information 510, e.g., operation time slot and period for simulation electric power verification.

The consumption electric power quantity data management apparatus 540 can verify validity and performance for the consumption electric power data based on the received simulation generation data 530.

As described above, apparatus for verifying and managing consumption electric power data in a green home electric power management system and method thereof according to the embodiment of the present invention can store and manage consumption electric power information collected from each home device through various data structures in order to analyze energy consumption data in various perspectives and can perform verification based on simulator supporting easy electric power functional verification in environment where long-term data storing is difficult.

In addition, according to apparatus for verifying and managing consumption electric power data in a green home electric power management system and method thereof in accordance with the embodiment of the present invention, consumption electric power information of each device can be analyzed in a consumption electric power quantity data managing apparatus and consumption electric power pattern analysis for an outlet of each location at home, a total consumption electric power quantity and a consumption electric power quantity information of each device for various time slots can be managed simultaneously. Thus, various analysis functions for the consumption pattern at the home can be provided to a user. In addition, Error of each of functional blocks can be prevented by measuring a simulation electric power quantity for the consumption electric power quantity data management apparatus through a verifying apparatus and more accurate management for consumption electric power quantity can be obtained.

While the invention has been shown and described with respect to the embodiments, it will be understood by those skilled in the art that various changes and modification may be made without departing from the scope of the invention as defined in the following claims.

What is claimed is:

1. An apparatus for verifying and managing consumption electric power data in a green home electric power management system, comprising:
an electric management object structure configured according to an outlet at home, an electric power sensor node of a hole of the outlet, a device and an equipment;
a consumption electric power data management apparatus for storing a consumption electric power data transmitted from an electric power measuring module embedded outlet in forms of an object management table and a time information table in the electric management object structure to manage consumption electric power information; and
a verifying apparatus for generating simulation consumption electric power data for verifying the consumption electric power data management apparatus.

2. The apparatus of claim 1, wherein the electric management object structure includes:
a home outlet table for managing information for whole outlets installed at home;
an outlet information table having at least one of an outlet ID (OID) of each of the outlets, a room location, a specific location of the each of the outlets, an instantaneous electric power and an accumulated electric power quantity for each of the outlets installed at the home;
a device information table having at least one of a Node ID (NID) of the electric power sensor node, an instantaneous electric power, and an accumulated electric power for each hole forming an outlet, and a device ID (DID) of a device connected to the each hole; and
an equipment information table having at least one of a heating and cooling device, a lighting device, a audio and video (AV) device, an information device and home equipment information for classifying and managing devices at the home according to a function and a usage,
wherein the tables are related to each other.

3. The apparatus of claim 2, wherein the consumption electric power quantity data management apparatus includes:
a node information analysis unit for outputting consumption electric power information for each outlet, each device, each equipment, a time slot through an analysis when the node information analysis unit receives the consumption electric power information of each device at the home, the consumption electric power information having at least one of a sensor node ID (NID), an instantaneous electric power, an accumulated electric power and time information;
an outlet information control unit for managing the outlet information table and the outlet hole information table by using information transmitted from the node information analysis unit; a device information control unit for managing the device information table and the equipment information table by using information transmitted from the node information analysis unit; and
an electric power quantity statistic information control unit for managing the time information table by using information transmitted from the node information analysis unit.

4. The apparatus of claim 1, wherein the time information table includes:
an annual accumulated electric power quantity table for managing information on an annual total electric accumulated electric power quantity and an annual electric accumulated electric power quantity of each device;
a monthly accumulated electric power quantity table for managing information of a monthly total electric accumulated electric power quantity and a monthly electric accumulated electric power quantity of each device;
a daily accumulated electric power quantity table for managing information of a daily total electric accumulated electric power quantity and a daily electric accumulated electric power quantity of each device;
a day for a week accumulated electric power quantity table for managing information of a total electric accumulated electric power quantity for a day for a week and an electric accumulated electric power quantity of each device for the day for a week; and
a time-slot accumulated electric power quantity table for managing information of a total electric accumulated electric power quantity for a time slot and an electric accumulated electric power quantity of each device for the time slot.

5. The apparatus of claim 1, wherein the verifying apparatus extracts node and device ID information from an outlet information table, outlet hole information and device information table in the electric power management object structure;
extracts a simulation generation information based on a consumption electric power quantity, an operation time and an electrical power consumption pattern of each device, and verification period;
generates simulation consumption electric power data by operating a simulator based on the node and device ID information; and
transmits the generated simulation consumption electric power data to the consumption electric power data management apparatus.

6. A method for verifying and managing consumption electric power data in a green home electric power management system, comprising:
receiving a consumption electric power data transmitted from a consumption electric power measuring module embedded outlet of a consumption electric power quantity data management apparatus; and
storing and managing the received consumption electric power data in forms of an object management table and a time information table in an electric power management object structure.

7. The method of claim 6, further comprising:
generating simulation consumption electric power data for verifying the consumption electric power quantity management apparatus by a verifying apparatus.

8. The method of claim 7, wherein the generating the simulation consumption electric power data includes:
extracting node and device ID information from an outlet information table, an outlet hole information table, and a device information table in the electric power management object structure;
extracting simulation generation information based on a consumption electric power quantity, an operation time and an electrical power consumption pattern of each device, and a simulation electric power verification period of each device;
generating a simulation consumption electric power data by operating a simulator based on the node and device ID information; and
transmitting the generated simulation consumption electric power data to the consumption electric power quantity management apparatus.

9. The method of claim 6, wherein the electric power management object structure includes:
a home outlet table for managing information for whole outlets installed at home;
an outlet information table having at least one of an outlet ID (OID), a room location, a specific location of each of the outlets, an instantaneous electric power and an accumulated electric power quantity for each of the outlets installed at the home;
a device information table having at least one of a Node ID (NID) of the electric power sensor node, an instantaneous electric power, and an accumulated electric power for each hole constituting an outlet, and a device ID (DID) of a device connected to the each hole; and
an equipment information table having at least one of a heating and cooling device, a lighting device, a audio and video (AV) device, information device and home equipment information for classifying and managing devices at the home according to a function and a usage,
wherein the tables are related to each other.

10. The method of claim 6, wherein the managing the received consumption electric power data includes:
outputting a consumption electric power information, in a node information analysis unit, for each outlet, each device, each equipment, a time slot through an analysis when the node information analysis unit receives the consumption electric power information of each device at the home, the consumption electric power information having at least one of a sensor node ID (NID), an instantaneous electric power, an accumulated electric power and time information.

11. The method of claim 10, wherein the managing the received consumption electric power data further includes:
managing the outlet information table and the outlet hole information table by using information transmitted from the node information analysis unit by an outlet information control unit;
managing the device information table and the equipment information table by using information transmitted from the node information analysis unit by a device information control unit; and
managing the time information table by using information transmitted from the node information analysis unit by an electric power quantity statistic information control unit.

12. The method of claim 6, wherein the time information table includes:
an annual accumulated electric power quantity table for managing information of an annual total electric accumulated electric power quantity and an annual electric accumulated electric power quantity of each device;
a monthly accumulated electric power quantity table for managing information of a monthly total electric accumulated electric power quantity and a monthly electric accumulated electric power quantity of each device;
a daily accumulated electric power quantity table for managing information of a daily total electric accumulated electric power quantity and a daily electric accumulated electric power quantity of each device;
a day for a week accumulated electric power quantity table for managing information of a total electric accumulated electric power quantity for a day for a week and an electric accumulated electric power quantity of each device for the day for a week; and
a time-slot accumulated electric power quantity table for managing information of a total electric accumulated electric power quantity for a time slot and an electric accumulated electric power quantity of each device for the time slot.
